(19) United States
(12) Patent Application Publication
(10) Pub. No.: US 2018/0144713 A1
(43) Pub. Date: May 24, 2018

(54) DISPLAY SYSTEM

(71) Applicant: TOYOTA JIDOSHA KABUSHIKI KAISHA, Toyota-shi (JP)

(72) Inventor: Taisuke KATAYAMA, Nisshin-shi (JP)

(73) Assignee: TOYOTA JIDOSHA KABUSHIKI KAISHA, Toyota-shi (JP)

(21) Appl. No.: 15/788,677

(22) Filed: Oct. 19, 2017

(30) Foreign Application Priority Data
Nov. 22, 2016 (JP) 2016-226857

(51) Int. Cl. G09G 5/00; G09G 5/393; G09G 5/14

(52) U.S. Cl. CPC G09G 5/006; G09G 5/393; G09G 5/14; G09G 2354/00; G09G 2370/20; G09G 2370/02; G09G 2380/10

(57) ABSTRACT

A display system includes a display device and a plurality of ECUs that include a first ECU and a second ECU. The second ECU is configured to transmit the identification information of the screen to the first ECU when the second ECU makes the display device display the screen. The first ECU is configured to receive an instruction to return the screen currently displayed on the display device to a previously displayed screen, and is configured to, when the return instruction is received, based on the correspondence relationship of the identification information of the screen, the identification information of the ECU, and the display order of the screen, which are store in the storage unit specify the ECU corresponding to the identification information of the previously displayed screen as a ECU that makes the display device display the previously displayed screen.

### INCORPORATION BY REFERENCE

The disclosure of Japanese Patent Application No. 2016-226857 filed on Nov. 22, 2016 including the specification, drawings and abstract is incorporated herein by reference in its entirety.

### BACKGROUND

### 1. Technical Field

The present disclosure relates to a display system in which a plurality of controllers makes screens be displayed at different timings.

### 2. Description of Related Art

An information processing apparatus including a storage unit configured to store a transition history of a screen is known. The information processing apparatus returns a screen to be displayed on the display device to a previously displayed screen based on the history stored in the storage unit in a case where an instruction to return a screen currently displayed on a display device to the previously displayed screen is received (for example, see Japanese Unexamined Patent Application Publication No. 2015-121869 (JP 2015-121869 A)).

### SUMMARY

In a display system in which a plurality of electronic control units makes screens be displayed in a display area of a display device at different timings, a history of a screen displayed in the display area is stored in each of the electronic control units in a state of being distributed in a storage unit of each of the electronic control units. As a result, even if a screen to be displayed on the display device is returned to a previously displayed screen, in the above-described display system, it is difficult to specify a electronic control unit that makes the previous screen be displayed.

The disclosure provides a display system in which a plurality of electronic control units makes screens be displayed in a display area at different timings, having an advantage of enabling specifying an electronic control unit that makes a previous screen be displayed.

An aspect of the disclosure relates to a display system including a display device configured to display a screen in a display area, and a plurality of electronic control units connected to a communication network. The electronic control units are configured to make the display device display the screen associated with identification information for identifying the screen at different timings, and include a first electronic control unit and a second electronic control unit. The second electronic control unit is configured to transmit the identification information of the screen to the first electronic control unit when the second electronic control unit makes the display device display the screen. The first electronic control unit is configured to store identification information of each screen made to be displayed by each of the electronic control units, identification information of an electronic control unit that makes each screen be displayed, and a display order of the screen displayed on the display device in a storage unit in correspondence with one another. The first electronic control unit is configured to receive an instruction to return the screen currently displayed on the display device to a previously displayed screen, and is configured to, when the return instruction is received, based on the correspondence relationship of the identification information of each screen, the identification information of the electronic control unit, and the display order of the screen, which are stored in the storage unit specify the electronic control unit corresponding to the identification information of the previously displayed screen as the electronic control unit that makes the display device display the previously displayed screen.

According to the aspect of the disclosure, the identification information of the screen displayed on the display device is stored in the first electronic control unit in correspondence with the identification information of the electronic control unit that makes the screen be displayed and the display order of the screen displayed on the display device. Then, the first electronic control unit is configured to receive the instruction to return the screen displayed on the display device to the previously displayed screen, and specify the electronic control unit corresponding to the identification information of the previously displayed screen as the electronic control unit that makes the screen be displayed. For this reason, in a display system in which a plurality of electronic control units makes screens be displayed in a display area at different timings, it is possible to specify an electronic control unit that makes a previous screen be displayed.

In the display system according to the aspect of the disclosure, the second electronic control unit may be configured to make a plurality of different screens be displayed at different timings. The first electronic control unit may be configured to, in a case where the electronic control unit that makes the previously displayed screen be displayed is specified to be the second electronic control unit, transmit identification information associated with the previously displayed screen to the second electronic control unit. The second electronic control unit may be configured to make the display device display a screen associated with the identification information received from the first electronic control unit.

According to the aspect of the disclosure, the second electronic control unit makes the display device display the different screens. Then, in a case where one screen displayed by the second electronic control unit is the previously displayed screen, the identification information for identifying the target is transmitted from the first electronic control unit to the second electronic control unit. For this reason, the second electronic control unit that makes the screens be displayed can perform processing for making the previously displayed screen be displayed.

In the display system according to the aspect of the disclosure, the first electronic control unit may be configured to, in a case where the electronic control unit that makes the previously displayed screen be displayed is specified to be the first electronic control unit, make the display device display the previously displayed screen.

According to the aspect of the disclosure, the first electronic control unit is included as a target for the electronic control unit that makes the previously displayed screen be displayed, and it is possible to allow the first electronic control unit to make the previously displayed screen be displayed.

In the display system according to the aspect of the disclosure, the second electronic control unit may be configured to, in a case where an event that causes transition of a screen displayed on the display device to another screen occurs, transmit identification information of the screen displayed before the transition to the first electronic control unit.

In the display system according to the aspect of the disclosure, the first electronic control unit may be configured to, in a case where an event that causes transition of a screen displayed on the display device to another screen occurs, store identification information of the screen displayed before the transition and identification information of the electronic control unit making the screen be displayed before the transition in the storage unit in correspondence with each other.

According to the aspect of the disclosure, in a case where the event that causes transition of the screen displayed on the display device to another screen occurs, the first electronic control unit stores a history relating to the screen before the transition. That is, when confirmation is made that the screen becomes a candidate of a return destination with the occurrence of the event, the first electronic control unit stores a history relating to the candidate. For this reason, it is possible to efficiently use a storage area in the first electronic control unit. In addition, it is possible to efficiently perform processing for writing or reading in the first electronic control unit.

In the display system according to the aspect of the disclosure, the first electronic control unit may be configured to receive an instruction to return to the previously displayed screen in a task, in which a plurality of screens is displayed, and erase information relating to each screen displayed in the task from the storage unit with reception of an end of the task.

According to the aspect of the disclosure, in a case where the task in which the screens are displayed ends, a request with each screen displayed in the task as a return destination is hard to occur. Since information relating to each screen displayed in the task is erased along with the end of the task, it is possible to efficiently use a storage area in the first electronic control unit in the next task.

In the display system according to the aspect of the disclosure, the first electronic control unit may be configured to receive an instruction to erase information relating to a screen made to be displayed by a specific electronic control unit among the electronic control units from the storage unit, and in a case where the instruction is received, erase a target to be erased from the storage unit.

According to the aspect of the disclosure, it is possible to remove the screen displayed by the specific electronic control unit among the electronic control units from candidates of the previously displayed screen.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram showing the schematic configuration of an embodiment in which a display system is embodied;

FIG. 2 is a sequence diagram showing an example of a processing procedure of a display history in the embodiment;

FIG. 3 is a diagram showing an example of an input/output form of the display history in the embodiment;

FIG. 4 is a diagram showing another example of the input/output form of the display history in the embodiment;

FIG. 5 is a diagram showing another example of the input/output form of the display history in the embodiment; and

FIG. 6 is a diagram showing another example of the input/output form of the display history in the embodiment.

### DETAILED DESCRIPTION OF EMBODIMENTS

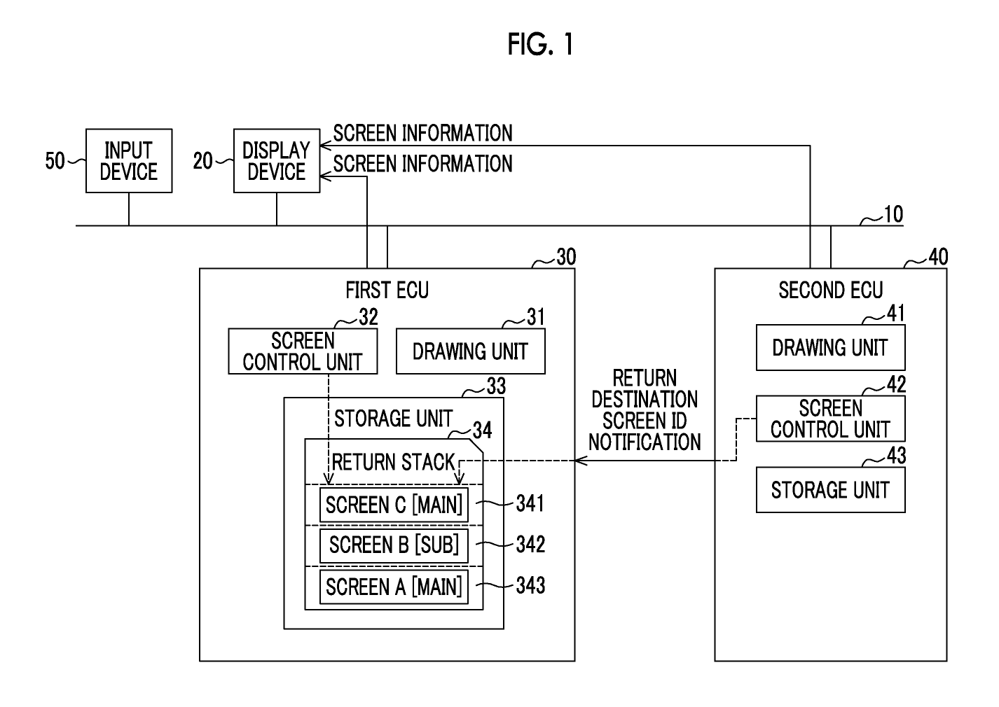

An embodiment in which a display system is embodied will be described referring to FIG. 1. The display system of the embodiment includes a communication system including a communication network mounted in a vehicle. First, the outline of the display system will be described referring to FIG. 1.

The communication system in the display system includes a first electronic control unit (ECU) 30 and a second electronic control unit (ECU) 40. The display system includes a display device 20 and an input device 50. The display device 20 displays a screen including video in a display area of a display. The input device 50 enables an input of operation from a driver or the like with respect to a history of a screen displayed on the display device 20.

The first ECU 30 and the second ECU 40 transmit screens to the display device 20. The first ECU 30 and the second ECU 40 make the screens transmitted from the first ECU 30 and the second ECU 40 be displayed on a display of the display device 20 at different timings. A screen is, for example, an image including a background image or a foreground image, and is constituted of one or more images that are displayed in the display area of the display at a time. The screens transmitted from the first ECU 30 and the second ECU 40 are, for example, an operation screen on which an operation situation of the vehicle is displayed, a list screen on which a list of musical pieces to be played is displayed, a menu screen that enables a selection of each screen, and the like.

The first ECU 30 stores time-dependent transition of the screens displayed on the display device 20 by the first ECU 30 and the second ECU 40 as a display history. For the display history stored by the first ECU 30, screen information that is information associated with each screen is used. When the input device 50 is operated by the driver or the like and one piece of screen information stored in the display history is selected, the first ECU 30 gives an instruction such that the display device 20 displays a screen associated with the one selected piece of screen information. An instruction target of the first ECU 30 is an ECU that makes the screen associated with the one selected piece of screen information be displayed.

Subsequently, the details of the display system will be described referring to FIG. 1. The communication system in the display system includes a communication bus 10 for a communication network. The display device 20, the first ECU 30, the second ECU 40, and the input device 50 are communicably connected to the communication bus 10.

The input device 50 is a device that is used when the driver or the like operates the display of the display device 20. The input device 50 enables an input of a “return” operation that is an operation to return a current screen to a screen previous to the current screen. When the “return” operation is input to the input device 50, the input device 50 transmits a “return” instruction as operation information as a result of the operation. The input device 50 may acquire the display history from the first ECU 30 and may display the acquired display history.

The display device 20 includes the display that displays a screen including video, and displays the screens received from the first ECU 30 and the second ECU 40 on the display at different timings. The first ECU 30 and the second ECU 40 receive the operation information transmitted from the input device 50. The operation information received by the first ECU 30 and the second ECU 40 includes the “return” instruction. The first ECU 30 and the second ECU 40 generate the screens that are displayed on the display device 20. The first ECU 30 and the second ECU 40 transmit the screens through the communication bus 10. The first ECU 30 and the second ECU 40 can perform transmission and reception of various communication messages with each other through the communication bus 10. The first ECU 30 and the second ECU 40 can perform transmission and reception of various communication messages with other ECUs than the first ECU 30 and the second ECU 40.

The communication system employs, for example, a controller area network (CAN) protocol as a communication protocol. The communication system may include wireless communication in a part of a communication path, or may include a path through another network through a gateway or the like.

In the CAN protocol, a frame that is a structure of a communication message is specified. The frame that is specified in the CAN protocol includes a storage area of a “message ID” as identification information indicating the type of communication message, a “data field” that is a storage area of “message data” that is data designated by a user, and the like. The “message ID” is determined to a specific value for each type of communication message. The first ECU 30 and the second ECU 40 gives, to the communication messages transmitted from the first ECU 30 and the second ECU 40, the “message IDs” corresponding to the types of the communication messages, transmit the communication messages, and determine the types of the communication messages received by the first ECU 30 and the second ECU 40 based on the “message IDs”. In the communication system, an ECU that can give the “message ID” to the communication message and transmit the communication message is one for each “message ID”, and is unique to each “message ID”. The “data field” that is an area where “message data” is stored has any length of 0 to 64 bits (0 to 8 bytes).

Each of the first ECU 30 and the second ECU 40 includes a microcomputer having an arithmetic device (CPU) and a storage device. Each of the first ECU 30 and the second ECU 40 includes an arithmetic device that executes arithmetic operation processing of a program, a read only memory (ROM) that stores the program, data, and the like, and a volatile memory (RAM) that temporarily stores an arithmetic operation result of the arithmetic device. Each of the first ECU 30 and the second ECU 40 includes a backup memory that stores a set value or an arithmetic operation value, a storage device, such as a flash memory, that stores data, and the like. Each of the first ECU 30 and the second ECU 40 reads the program stored in the storage device on the arithmetic device and executes the read program to realize a predetermined function.

Each of the first ECU 30 and the second ECU 40 includes a communication I/F for a CAN protocol, a plurality of message boxes (MBOX) that temporarily stores the communication messages, and the like. Each of the first ECU 30 and the second ECU 40 performs transmission and reception of the communication message through the communication I/F or the MBOX. The first ECU 30 and the second ECU 40 include drawing units 31, 41, and screen control units 32, 42, respectively, and the first ECU 30 includes a storage unit 33.

The drawing units 31, 41 generate different screens based on screen information instructed by the screen control units 32, 42 corresponding to the drawing units 31, 41. The drawing units 31, 41 perform processing for transmitting the screens generated by the drawing units 31, 41 to the display device 20.

The screen control units 32, 42 control the types of the screens transmitted from the screen control units 32, 42 and the timings of transmitting the screens. For example, the screen control units 32, 42 select the types of the screens transmitted from the screen control units 32, 42 as screen information associated with the screens. The screen control units 32, 42 transmit the screen information selected by the screen control units 32, 42 to the drawing units 31, 41 corresponding to the screen control units 32, 42.

In a case where the first ECU 30 transmits the screen, the screen control unit 32 transmits, to the second ECU 40, screen transition notification that is notification to the effect that the screen is transmitted from the first ECU 30. In a case where the second ECU 40 transmits the screen, the screen control unit 42 transmits, to the first ECU 30, screen transition notification that is notification to the effect that the screen is transmitted from the second ECU 40. A screen that is displayed on the display device 20 is a latest screen. When the screen is displayed, the first ECU 30 stops the transmission of the screen from the screen control unit 32 with the second ECU 40 receiving the notification to the effect that the screen is transmitted from the first ECU 30. When the screen is displayed, the second ECU 40 stops the transmission of the screen from the screen control unit 42 with the first ECU 30 receiving the notification to the effect that the screen is transmitted from the second ECU 40. The display device 20 displays either of the screen transmitted from the first ECU 30 or the screen transmitted from the second ECU 40.

The first ECU 30 and the second ECU 40 include the storage units 33, 43 that store screen data and the like, respectively. The storage units 33, 43 enable reading and writing of data from and to the drawing units 31, 41 and the screen control units 32, 42.

The storage unit 33 includes a return stack 34. The return stack 34 is a memory, so-called a stack memory, where data is output and input (pushed and popped) such that data written last is read first. Inside the return stack 34, a first screen information storage unit 341, a second screen information storage unit 342, and a third screen information storage unit 343 are provided. The first to third screen information storage units 341 to 343 are areas where screen information of a screen to be a candidate of a return destination can be stored.

The screen information includes a combination of a controller ID, and a screen ID that is an ID of a screen. The controller ID is a numeral for enabling the first ECU 30 to identify an ECU that makes a screen be displayed. The screen ID is an example of identification information associated with a screen, and is a numeral for enabling the first ECU 30 and the second ECU 40 to identify a specific screen. The return stack 34 makes data be written (pushed) in an order of the third screen information storage unit 343, the second screen information storage unit 342, and the first screen information storage unit 341. That is, the first ECU 30 stores the correspondence relationship of the screen ID, the controller ID, and a display order of a screen corresponding to the screen ID on the display device 20 using the return stack 34. For example, when three pieces of data are written, first data is stored in the third screen information storage unit 343, second data is stored in the second screen information storage unit 342, and third data is stored in the first screen information storage unit 341. The return stack 34 makes data be read (popped) in an order of the first screen information storage unit 341, the second screen information storage unit 342, and the third screen information storage unit 343. For example, when three pieces of data are read, data in the first screen information storage unit 341 is read first, and data in the second screen information storage unit 342 is read second, and data in the third screen information storage unit 343 is read third.

In the return stack 34 shown in FIG. 1, as an example, a “screen A [main]” is stored in the third screen information storage unit 343, a “screen B [sub]” is stored in the second screen information storage unit 342, and a “screen C [main]” is stored in the first screen information storage unit 341. The “screen A [main]” indicates screen information, and indicates including a set of data having a screen ID for identifying a “screen A” and a controller ID for identifying an ECU that makes the “screen A” be displayed. In the following description, the screen information stored in the first to third screen information storage units 341 to 343 are indicated in the same manner. It should be noted that [main] indicates a controller ID for identifying the first ECU 30, and [sub] indicates a controller ID for identifying the second ECU 40.

In a case where the “return” operation is input from the input device 50, the screen control unit 32 reads screen information from the return stack 34. That is, in the first ECU 30, one piece of screen information is “popped” from the return stack 34, and latest screen information is acquired. In order to draw a screen associated with the latest screen information again, the screen control unit 32 transmits the latest screen information to an ECU that makes the screen be displayed.

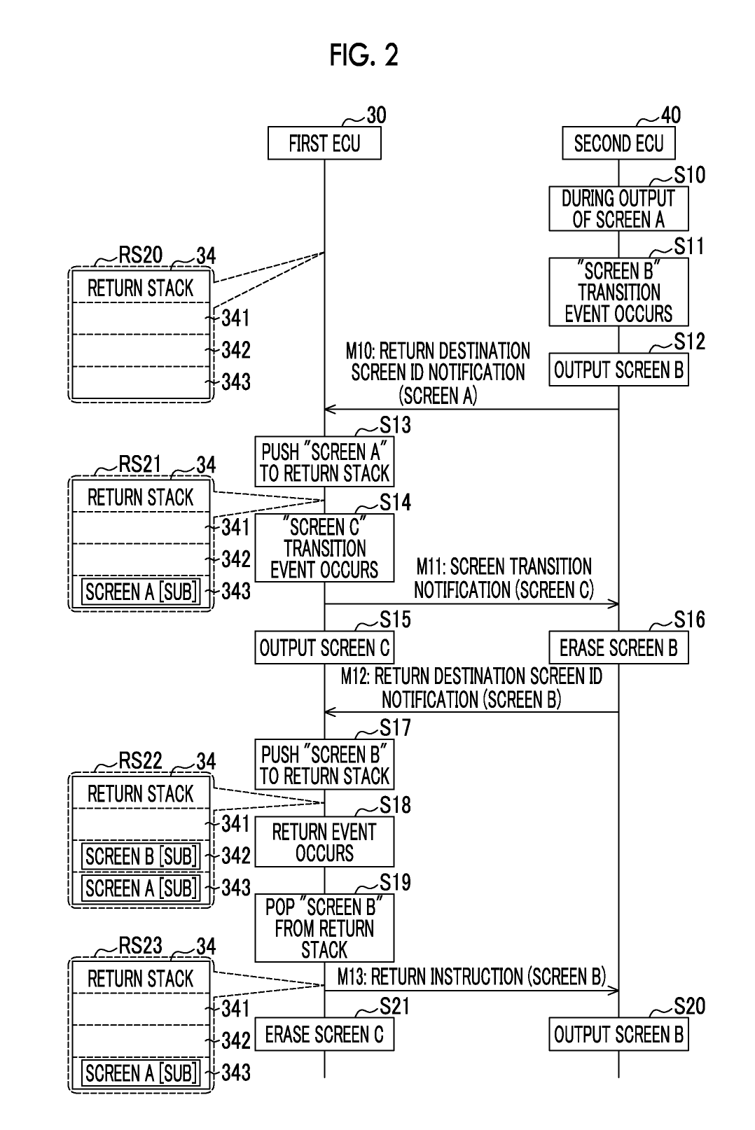

The functions of the drawing units 31, 41, the screen control units 32, 42, and the return stack 34 are realized by arithmetic operation processing of a program by the first ECU 30 or the second ECU 40. An operation example of the “return” operation will be described referring to FIG. 2. Here, a case where the screen information that is transmitted from the second ECU 40 is stored in the first ECU 30 will be described.

First, the state of the return stack 34 is a state RS20 in which the screen information is not stored in the first to third screen information storage units 341 to 343, and a period in which the second ECU 40 makes the display device 20 display the screen A (Step S10). Next, an event that causes transition of the display on the display device 20 from the screen A to a screen B occurs in the second ECU 40 (Step S11). The second ECU 40 transmits the screen B to the display device 20 (Step S12), and makes the display device 20 display the screen B. The second ECU 40 gives the first ECU 30 notification that the second ECU 40 makes the display device 20 display the screen B. Then, the second ECU 40 transmits, to the first ECU 30, the screen ID of the screen A transmitted previously to the screen B newly transmitted as return destination screen ID notification M10.

The first ECU 30 receives the return destination screen ID notification M10 and pushes the “screen A” to the return stack 34 (Step S13). For convenience, while it is described that the “screen A” is pushed to the return stack 34, this means storing the screen information associated with the “screen A” in the return stack 34, and the same applies to the following. With this, the return stack 34 stores a “screen A [sub]” in the third screen information storage unit 343 as shown in a state RS21.

Subsequently, an event that causes transition of the display on the display device 20 from the screen B to a screen C occurs in the first ECU 30 (Step S14). The first ECU 30 transmits (outputs) the screen C to the display device 20 (Step S15), and makes the display device 20 display the screen C. The first ECU 30 transmits, to the second ECU 40, the first ECU 30 making the display device 20 display the screen C as screen transition notification M11. The second ECU 40 stops the transmission of the “screen B” according to the screen transition notification M11 (Step S16). Then, the second ECU 40 transmits, to the first ECU 30, the screen ID of the screen B displayed previously to the screen C newly displayed as return destination screen ID notification M12.

The first ECU 30 receives the return destination screen ID notification M12 and pushes the “screen B” to the return stack 34 (Step S17). With this, as shown in a state RS22, the return stack 34 stores two pieces of screen information of the “screen B [sub]” and the “screen A [sub]”.

Thereafter, a “return” event occurs in the first ECU 30 (Step S18). For example, the “return” event occurs according to the “return” operation of the input device 50. Then, the first ECU 30 pops the “screen B” from the return stack 34 (Step S19). With this, as shown in a state RS23, the “screen B [sub]” is read from the return stack 34, and the “screen A [sub]” is stored in the return stack 34 alone.

The first ECU 30 transmits an instruction to make the “screen B” be displayed, called a return instruction M13, to the second ECU 40 corresponding to [sub] based on the “screen B [sub]” read from the return stack 34. When the return instruction M13 is received, the second ECU 40 transmits the screen B included in the instruction to the display device 20 (Step S20), and makes the display device 20 display the screen B. The first ECU 30 transmits the return instruction M13 to the second ECU 40 and stops the transmission of the “screen C” (Step S21). With this, the screen that is displayed on the display device 20 transits from the screen C to the new screen B.

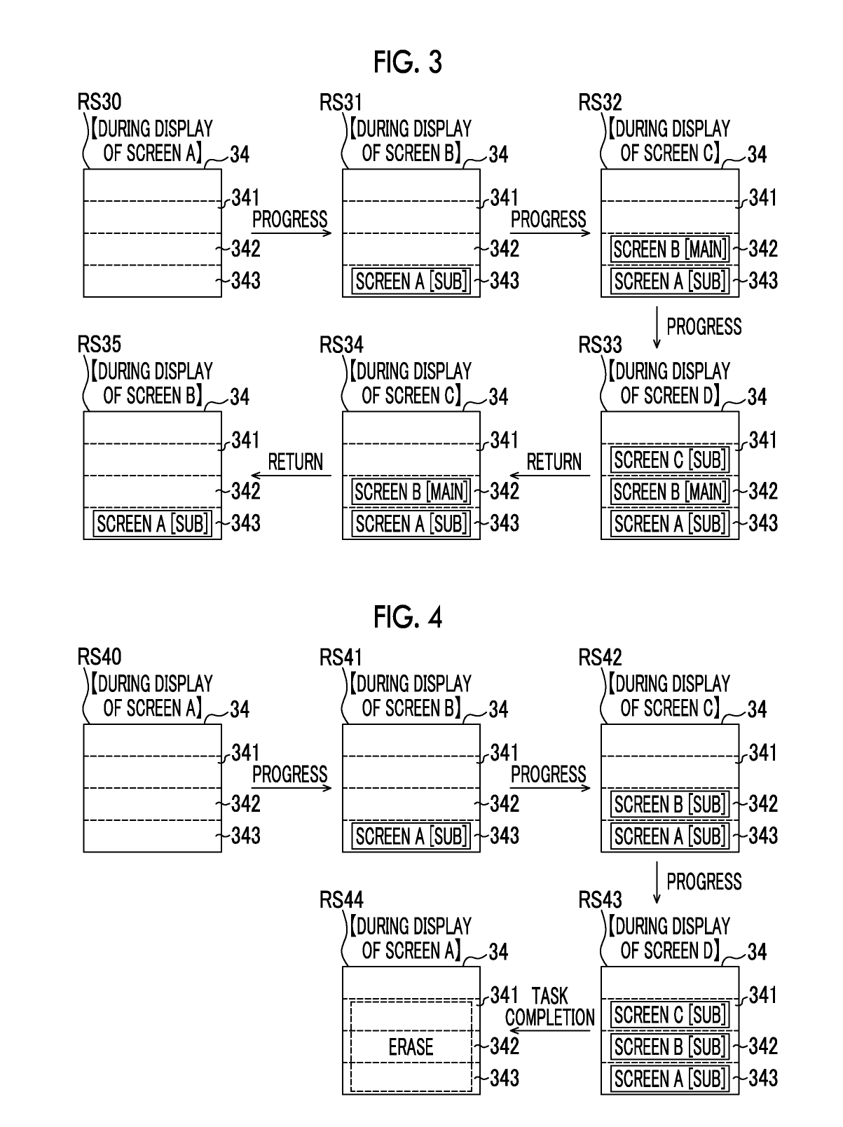

Each operation example of the display system according to the “return” operation will be described referring to FIGS. 3 to 6. FIG. 3 shows an operation example of the display system in a case where a screen displayed by the first ECU 30 and a screen displayed by the second ECU 40 are mixed in a display history.

Referring to FIG. 3, first, during a period in which the second ECU 40 makes the screen A be displayed, the return stack 34 does not store the screen information (state RS30). Next, in a case where the first ECU 30 makes the screen B be displayed, the return stack 34 stores the “screen A [sub]” (state RS31). Then, in a case where the second ECU 40 makes the screen C be displayed, the return stack 34 stores the “screen B [main]” and the “screen A [sub]” in a last-in order (state RS32). In addition, in a case where either of the ECUs 30, 40 makes a screen D be displayed, the return stack 34 stores a “screen C [sub]”, the “screen B [main]”, and the “screen A [sub]” in a last-in order (state RS33).

Thereafter, in a case where the “return” operation is performed, the “screen C [sub]” stored last in the return stack 34 is popped, and the return stack 34 stores the “screen B [main]” and the “screen A [sub]” in a last-in order (state RS34). At this time, the popped “screen C [sub]” is transmitted from the first ECU 30 to the second ECU 40, and the screen C transmitted from the second ECU 40 is displayed on the display device 20. Thereafter, in a case where the “return” operation is performed, the “screen B [main]” input last to the return stack 34 is popped, and the return stack 34 stores the “screen A [sub]” (state RS35). At this time, the popped “screen B [main]” is processed by the first ECU 30, and the screen B transmitted from the first ECU 30 is displayed on the display device 20.

As described above, since the histories of the screens displayed by a plurality of ECUs 30, 40 are managed by the single return stack 34 in the first ECU 30, the display by the ECUs 30, 40 is easily controlled.

FIG. 4 shows an operation example of the display system in a case where a task ends and in a case where a screen displayed in the task is excluded from a target subjected to the “return” operation. A task is a series of processing in which the “return” operation is needed during a period in which the task is performed.

Referring to FIG. 4, first, during a period in which the second ECU 40 makes the screen A be displayed, the return stack 34 does not store the screen information (state RS40). Next, in a case where the second ECU 40 makes the screen B be displayed, the return stack 34 stores the “screen A [sub]” (state RS41). Then, in a case where the second ECU 40 makes the screen C be displayed, the return stack 34 stores the “screen B [sub]” and the “screen A [sub]” in a last-in order (state RS42). In addition, in a case where either of the ECUs makes the screen D be displayed, the return stack 34 stores the “screen C [sub]”, the “screen B [sub]”, and the “screen A [sub]” in a last-in order (state RS43). Then, in a case where a task ends, since there is no need to use the display history, the return stack 34 erases all pieces of stored screen information (state RS44). The display device 20 displays the screen A transmitted from the second ECU 40, for example, as an initial screen for performing a task. Such erasing of the display history is performed by the first ECU 30, for example, in a case where a task ends, such as a case where a task is completed or a case where a task is stopped halfway.

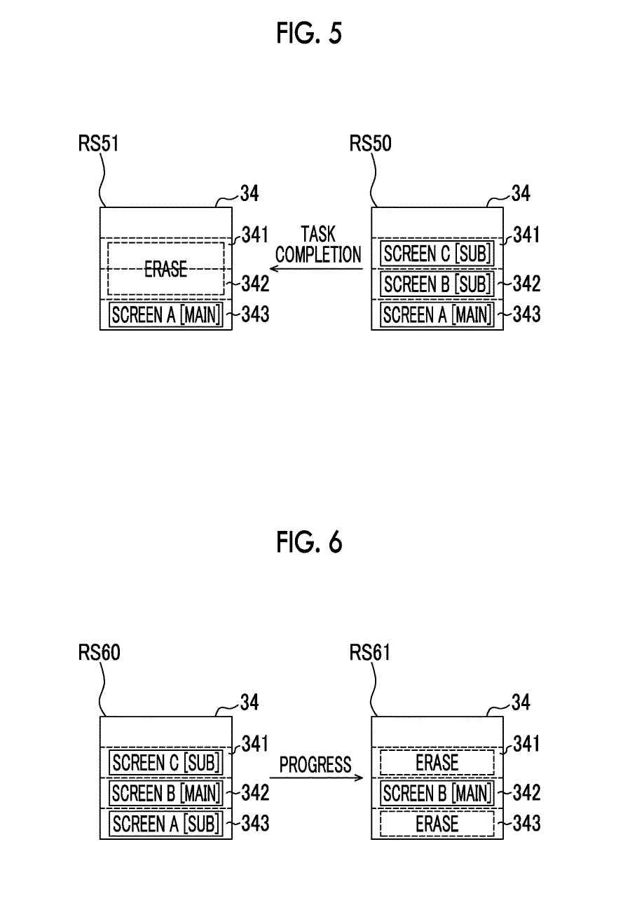

FIG. 5 shows an operation example of the display system in a case where processing of a task branched from a main task ends and a screen displayed in the branched task is excluded from a target subjected to the “return” operation. The main task is a series of processing in the first ECU 30 in which the “return” operation is needed, and the branched task is a series of processing in the second ECU 40 in which the “return” operation is needed.

Referring to FIG. 5, during a period in which either of the ECUs makes the screen D be displayed, the return stack 34 stores the “screen C [sub]”, the “screen B [sub]”, and the “screen A [main]” in a last-in order (state RS50). Then, in a case where an example of processing in charge by the second ECU 40 ends, the return stack 34 erases the screen information related to the branched task. That is, the return stack 34 erases all pieces of screen information having [sub] that is the controller ID for identifying the second ECU 40. The return stack 34 stores the “screen A [main]” in the screen information storage unit 343 alone (state RS51). Partial erasing of the display history is performed by the first ECU 30, for example, in a case where a task ends, such as a case where the branched task is completed or a case where the branched task is stopped halfway.

FIG. 6 shows an operation example of the display system in a case where a screen displayed by the second ECU 40 is excluded from a target subjected to the “return” operation. Referring to FIG. 6, during a period in which either of the ECUs makes the screen D be displayed, the return stack 34 stores the “screen C [sub]”, the “screen B [main]”, and the “screen A [sub]” in a last-in order (state RS60). Then, when processing relating to the second ECU 40 further progresses, the return stack 34 erases the screen information related to the second ECU 40. That is, the return stack 34 erases all pieces of screen information including [sub] that is the controller ID for identifying the second ECU 40. The return stack 34 stores the “screen B [main]” in the screen information storage unit 342 alone (state RS61). Selection of a screen to be erased is performed by the first ECU 30 under predetermined conditions, for example.

As described above, according to the display system, the following effects are obtained. (1) The first ECU 30 stores the screen information including a combination of the controller ID and the screen ID in an order of the screens displayed on the display device 20. Then, based on the controller ID included in the screen information corresponding to the previously displayed screen, the first ECU 30 specifies, as an ECU that makes the previous screen be displayed, an ECU that is identified from the controller ID. For this reason, in the display system in which the first ECU 30 and the second ECU 40 make the screens be displayed in the display area at different timings, it is possible to specify an ECU that makes the previous screen be displayed.

(2) In a case where one of the screens displayed by the second ECU 40 is the previously displayed screen, the screen ID for identifying the screen is transmitted from the first ECU 30 to the second ECU 40. For this reason, the second ECU 40 that makes a plurality of screens be displayed can perform processing for displaying the previously displayed screen such as ascertaining of the previously displayed screen, and displaying of the ascertained screen.

(3) The return stack 34 of the first ECU 30 stores the screen information relating to the screens displayed by the first ECU 30 in an order of the screens displayed on the display device 20 in addition to the screen information relating to the screens displayed by the second ECU 40. For this reason, the display system can include the first ECU 30 as an ECU that makes the previously displayed screen be displayed.

(4) In a case where an event that causes transition of a screen occurs, the first ECU 30 stores, as a history relating to a screen before transition, the screen information relating to the screen. As a result, when confirmation is made that the screen becomes a candidate of a return destination with the occurrence of the event, the first ECU 30 stores screen information relating to the candidate. For this reason, compared to a configuration in which a displayed screen is stored, including a currently displayed screen, each time display is made, it is possible to efficiently use a storage area in the return stack 34 and to efficiently perform processing of writing or reading using the return stack 34.

(5) The screen information relating to each screen displayed in a task is erased along with the end of the task. For this reason, it is possible to efficiently use the return stack 34 in the next task.

(6) In a case where there is a task branched off from a main task, the first ECU 30 can erase all display histories relating to the branched task in a state in which other display histories are stored.

(7) The first ECU 30 can erase all pieces of screen information including the controller ID for identifying the second ECU 40. For this reason, in a case where the operation of the second ECU 40 is stopped, and in a case where there is no need to return the screen relating to the second ECU 40, or the like, it is possible to prevent the screen displayed by the second ECU 40 from being selected and returned.

The embodiment can be carried out in the following forms.

### Screen Information

In erasing the screen information stored in the return stack 34, a configuration may be made in which the screen ID to be erased and erasing of the screen ID are received by the first ECU 30 as an instruction, and the first ECU 30 performs erasing for each screen ID. In a configuration in which erasing is enabled for each screen ID, for example, in regard to a screen to be a return destination with a frequency lower than other screens, it is possible to selectively erase the screen information relating to the screen. As a result, it is possible to reduce the frequency of the “return” operation until return is made to a desired screen.
In erasing the screen information stored in the return stack 34, a configuration may be made in which the order of the screen information to be erased and erasing of the screen information are received by the first ECU 30 as an instruction, and the screen information is erased one by one. In a configuration in which one piece of screen information selected by an operation can be erased, it is possible to increase selectivity of the screen information stored in the return stack 34, and consequently, selectivity of a screen to be a return destination.
In erasing the screen information stored in the return stack 34, a configuration may be made in which the first ECU 30 erases the screen information in order from the last written screen information each time new screen information that is written to the return stack 34 is generated.
When an event that causes transition of a screen occurs in the second ECU 40, the second ECU 40 that makes the display device 20 display the screen transmits, to the first ECU 30, the screen ID that is the identification information of the screen. Alternatively, when a screen is displayed before an event that causes transition of the screen occurs, the second ECU 40 that makes the display device 20 display the screen may transmit, to the first ECU 30, the screen ID that is the identification information of the screen.

### Return Stack

The number of pieces of the screen information that can be stacked in the return stack 34 may be less than three or equal to or greater than four. That is, the number of screen information storage units may be less than three or equal to or greater than four. The controller ID that is stored in the return stack 34 may stand for a plurality of second ECU 40 other than the first ECU 30. The above-described configuration is suitable for a case where there is no possibility that a screen displayed by the first ECU 30 becomes a candidate of a return destination.
The first ECU 30 may select screen information with a common controller ID based on the screen information that is stored in the return stack 34. Then, the first ECU 30 may edit the order of the selected screen information out of the screen information stored in the return stack 34. The first ECU 30 may perform processing of the “return” operation based on the edited order.

Operation Information
A configuration may be made in which the input device 50 inputs an operation to return a current screen to a screen displayed by two or more screens before the current screen. At this time, the first ECU 30 returns a screen displayed on the display device 20 to a previously displayed screen by the number of screens designated by the operation. In the return stack 34, screen information of the number of screens to be a candidate of a return destination is storable, and screen information written before a number of screens designated by the operation is read, instead of first reading data written last.

### Others

The number of types of screens that are displayed by the first ECU 30 and the second ECU 40 may be one or equal to or greater than three. The number of second ECUs 40 may be equal to or greater than two.
In the embodiment, a case where the communication protocol is the CAN protocol has been illustrated. The disclosure is not limited thereto, and the communication protocol may be a protocol other than the CAN protocol, for example, a communication protocol, such as Ethernet (Registered Trademark) or FlexRay (Registered Trademark).

What is claimed is:

1. A display system comprising:
a display device configured to display a screen in a display area; and
a plurality of electronic control units connected to a communication network, the electronic control units being configured to make the display device display the screen associated with identification information for identifying the screen at different timings, wherein:
the electronic control units include a first electronic control unit and a second electronic control unit;
the second electronic control unit is configured to transmit the identification information of the screen to the first electronic control unit when the second electronic control unit makes the display device display the screen; and
the first electronic control unit is configured to store identification information of each screen made to be displayed by each of the electronic control units, identification information of an electronic control unit that makes each screen be displayed, and a display order of the screen displayed on the display device in a storage unit in correspondence with one another, is configured to receive an instruction to return the screen currently displayed on the display device to a previously displayed screen, and is configured to, when the return instruction is received, based on the correspondence relationship of the identification information of each screen, the identification information of the electronic control unit, and the display order of the screen, which are stored in the storage unit specify the electronic control unit corresponding to the identification information of the previously displayed screen as the electronic control unit that makes the display device display the previously displayed screen.

2. The display system according to claim 1, wherein the second electronic control unit is configured to make a plurality of different screens be displayed at different timings, the first electronic control unit is configured to, in a case where the electronic control unit that makes the previously displayed screen be displayed is specified to be the second electronic control unit, transmit identification information associated with the previously displayed screen to the second electronic control unit, and the second electronic control unit is configured to make the display device display a screen associated with the identification information received from the first electronic control unit.

3. The display system according to claim 1, wherein the first electronic control unit is configured to, in a case where the electronic control unit that makes the previously displayed screen be displayed is specified to be the first electronic control unit, make the display device display the previously displayed screen.

4. The display system according to claim 1, wherein the second electronic control unit is configured to, in a case where an event that causes transition of a screen displayed on the display device to another screen occurs, transmit identification information of the screen displayed before the transition to the first electronic control unit.

5. The display system according to claim 1, wherein the first electronic control unit is configured to, in a case where an event that causes transition of a screen displayed on the display device to another screen occurs, store identification information of the screen displayed before the transition and identification information of the electronic control unit making the screen displayed before the transition in the storage unit in correspondence with each other.

6. The display system according to claim 1, wherein the first electronic control unit is configured to receive an instruction to return to the previously displayed screen in a task, in which a plurality of screens is displayed, and erase information relating to each screen displayed in the task from the storage unit with reception of an end of the task.

7. The display system according to claim 1, wherein the first electronic control unit is configured to receive an instruction to erase information relating to a screen made to be displayed by a specific electronic control unit among the electronic control units from the storage unit, and in a case where the instruction is received, erase a target to be erased from the storage unit.
